(19) United States
(12) Patent Application Publication
(10) Pub. No.: US 2017/0208990 A1
(43) Pub. Date: Jul. 27, 2017

(54) FEED UNIT FOR FEEDING A LIQUID FOODSTUFF TO A BEVERAGE DISPENSING DEVICE AND METHOD FOR CLEANING AT LEAST ONE FEED UNIT FOR FEEDING A LIQUID FOODSTUFF TO A BEVERAGE DISPENSING DEVICE

(71) Applicant: Franke Kaffeemaschinen AG, Aarburg (CH)

(72) Inventors: Mariano TURI, Zurich (CH); Heinz VETTERLI, Wangen (CH)

(73) Assignee: Franke Kaffeemaschinen AG, Aarburg (CH)

(21) Appl. No.: 15/328,652

(22) PCT Filed: Aug. 3, 2015
(86) PCT No.: PCT/EP2015/067792

§ 371 Date: Jan. 24, 2017

(30) Foreign Application Priority Data
Aug. 7, 2014 (DE) 10 2014 215 689.0

(51) Int. Cl. A47J 31/60; B08B 9/032

(52) U.S. Cl. CPC A47J 31/60; B08B 9/0325

(57) ABSTRACT

The invention relates to a feed unit (1) for feeding a liquid foodstuff to a beverage dispensing device, the feed unit having a feed line (2) for feeding the liquid foodstuff from a foodstuff tank (3) to the feed unit (1), a cleaning agent tank (3) for a cleaning agent, and also a cleaning agent pump (7) for conveying the cleaning agent out of the cleaning agent tank (8), the feed unit being characterized in that the device has a cleaning-agent mixing tank (6), which optionally can be arranged at or in the feed unit (1) in a cleaning mode and can be removed from the feed unit (1) in a foodstuff dispensing mode, wherein, in the cleaning mode, cleaning agent can be fed from the cleaning agent tank (8) to the cleaning-agent mixing tank (6) by the cleaning agent pump (7), and cleaning agent and/or a cleaning mixture can be discharged out of the cleaning-agent mixing tank (6) by the feed line (2). The invention also relates to a method for cleaning at least one feed unit (1) for feeding a liquid foodstuff to a beverage dispensing device (10).

The invention relates to a feed unit (1) for feeding a liquid foodstuff to a beverage dispensing device, the feed unit having a feed line (2) for feeding the liquid foodstuff from a foodstuff tank (3) to the feed unit (1), a cleaning agent tank (3) for a cleaning agent, and also a cleaning agent pump (7) for conveying the cleaning agent out of the cleaning agent tank (8), the feed unit being characterized in that the device has a cleaning-agent mixing tank (6), which optionally can be arranged at or in the feed unit (1) in a cleaning mode and can be removed from the feed unit (1) in a foodstuff dispensing mode, wherein, in the cleaning mode, cleaning agent can be fed from the cleaning agent tank (8) to the cleaning-agent mixing tank (6) by the cleaning agent pump (7), and cleaning agent and/or a cleaning mixture can be discharged out of the cleaning-agent mixing tank (6) by the feed line (2). The invention also relates to a method for cleaning at least one feed unit (1) for feeding a liquid foodstuff to a beverage dispensing device (10).

### BACKGROUND

The invention relates to a feed unit for feeding a liquid foodstuff to a beverage dispensing device as well as a method for cleaning at least one feed unit for feeding a liquid foodstuff to a beverage dispensing device.

Devices for dispensing beverages typically comprise a feed unit for feeding a liquid foodstuff. They are frequently used to feed liquid additives to the beverage dispensing device, particularly to provide additives for preparing a mixed drink. For example, feed units are used to feed milk and/or other liquid flavorings, such as syrup, to automatic coffee makers in order to discharge the liquid foodstuff together with the coffee or to add it to the coffee drink after further processing of the liquid foodstuff, such as frothing milk.

Such devices must be regularly cleaned in order to ensure hygiene standards and to prevent deposits. In particularly when using such devices in large facilities, here regular cleaning is required, usually on a daily basis, which has to meet mandatory standards.

EP 2 078 481 discloses cleaning arrangement comprising a cleaning agent tank, a dosing pump, and a discharge chamber, arranged at or in an automatic coffee maker for the purpose of cleaning.

A machine is known from DE 20 2010 010 509 U1 for producing mixed coffee drinks which comprises a dosing device, a cleaning agent tank, and a discharge chamber for mixing the cleaning agent with water.

### SUMMARY

The present invention is based on the objective to simplify for the operator the cleaning of a feeding unit for feeding a liquid foodstuff to a drink dispensing unit and here reduce the risk of errors during the cleaning process.

This objective is attained in a feed unit with one or more features of the invention as well as a method for cleaning at least one feed unit. Hereby the wording of all claims is included in the description.

The feed unit according to the invention is preferably embodied to implement the method according to the invention, particularly a preferred embodiment thereof. The method according to the invention is preferably embodied to be implemented via a feed unit according to the invention, particularly a preferred embodiment thereof.

The feed unit according to the invention for feeding a liquid foodstuff to a beverage dispensing device comprises a feed line for feeding a liquid foodstuff from a foodstuff tank to the feed unit and a cleaning tank for a cleaning agent as well as a cleaning agent pump for conveying the cleaning agent out of the cleaning agent tank.

It is essential that the device comprises a cleaning agent mixing container, which in a cleaning mode can be arranged optionally at or in the feed unit and can be removed from the feed unit in a food dispensing mode. In a typical operating mode, in which the liquid foodstuff is fed to the beverage dispensing unit the cleaning agent mixing container is therefore removed. In the cleaning mode for cleaning at least one feed unit the cleaning agent mixing container is however arranged at or in the feed unit. In the cleaning mode the cleaning agent mixing container is arranged at or in the feed unit such that cleaning agent can be fed via the cleaning agent pump out of the cleaning agent tank to the cleaning agent mixing container, and the cleaning agent and/or the cleaning agent mixture can be discharged via the feed line out of the cleaning agent mixing container.

The feed unit according to the invention therefore shows the advantage that the cleaning agent mixing container can be embodied independent from the other components of the feed unit and the foodstuff dispensing mode and the cleaning mode are easily distinguished for the operator by the arrangement of the cleaning agent mixing container at or in the feed unit. This way, both the operation of the feed unit, particularly the switch between the cleaning mode and the foodstuff dispensing mode, is simplified for the operator and thus potential sources for errors are reduced.

The method according to the invention for cleaning via at least one feed unit for feeding a liquid foodstuff to a beverage dispensing device comprises the following processing steps:

In a processing step A, a cleaning agent mixing container is arranged at or in the feed unit and a fluid-conducting connection occurs of a feed line of the feed unit to the cleaning agent mixing container.

In a processing step B, a feeding occurs of at least one cleaning agent from a cleaning agent tank to the cleaning agent mixing container.

In a processing step C, the cleaning agent or a cleaning agent mixture is drained from the cleaning agent mixing container via the feed line in order to clean at least one feed unit.

It is essential that in a foodstuff dispensing mode the feed line is connected in a fluid conducting fashion to the foodstuff tank and in a cleaning mode the feed line is connected in a fluid conducting fashion to the cleaning agent mixing container instead to the foodstuff tank.

The method according to the invention therefore comprises the advantages mentioned in the context with the device according to the invention, in which particularly the exchange of the foodstuff tank for the cleaning agent mixing container and accordingly the connection of the feed line conducting fluids, instead to the foodstuff tank, to the cleaning agent mixing container is characterized for the operator in a simple fashion by the exchange between the foodstuff dispensing mode and the cleaning mode.

The cleaning mode comprises here a cleaning of at least parts of the feed unit, by at least the feed line being cleaned and preferably additional components connected thereto in a fluid conducting fashion, such as a conveyer pump. Preferably the cleaning process is here performed in a manner known per se, by additional components, particularly also components of the beverage dispensing device connected to the feed unit being cleaned via the cleaning agent and/or the cleaning agent mixture conveyed out of the cleaning agent mixing container.

In the following the term “cleaning agent” is used for the cleaning agent conveyed out of the cleaning agent mixing container, independent of the fact if this represents any undiluted cleaning agent or a cleaning agent mixture which is diluted with a diluent, such as water.

The feed unit according to the invention may be embodied as a feed unit for feeding a liquid foodstuff to a beverage dispensing device of prior art. Preferably the feed unit is embodied for feeding a liquid foodstuff to a beverage dispensing device embodied as an automatic coffee maker, particularly preferred as a fully-automated coffee maker. The scope of the invention also includes that the feed unit is provided for supplying a liquid foodstuff to a differently embodied beverage dispensing device, for example a beverage dispensing device for dispensing alcoholic or non-alcoholic drinks, particularly so-called refreshments (“soft drinks”).

The liquid foodstuff supplied via the feed unit may represent a liquid flavoring, such as syrup. In particular when the beverage dispensing devices is embodied as an automatic coffee maker the feed unit is preferably provided for supplying milk as a liquid foodstuff to the beverage dispensing device embodied as an automatic coffee maker. In particular the use of milk in a feed unit and/or a beverage dispensing device requires a particular extent of hygiene and thus sets high requirements for the cleaning process.

In a preferred embodiment the feed unit may be designed as a separate unit to be arranged next to the beverage dispensing device. Here, the feed unit preferably comprises at least one foodstuff discharge connection for a connection in a fluid conducting fashion to a foodstuff feed connection of the beverage dispensing device. Furthermore, here the feed unit is embodied such that the foodstuff can be conveyed via the foodstuff discharge connection of the beverage dispensing device to be discharged, perhaps after any further processing, such as frothing.

Further preferred, the feed unit comprises here a control connection, which can be connected in an electrically conducting fashion to a control output of the beverage dispensing device such that control signals of the dispensing device can be transmitted for controlling the components of the feed unit, particularly pumps and valves of the feed unit, and thus the function of the feed unit can be controlled via the beverage dispensing device, particularly the feeding of the liquid foodstuff and/or the execution of the cleaning process.

In another preferred embodiment the feed unit is integrated in the beverage dispensing device. The beverage dispensing device according to the invention comprises therefore according to this exemplary embodiment a feed unit according to the invention and/or a preferred embodiment thereof. In particular in this exemplary embodiment the feed unit is preferably arranged in a housing of the beverage dispensing device.

As already mentioned, here in a simple fashion the operator can distinguish between the foodstuff dispensing mode and the cleaning mode by the fact that in the foodstuff dispensing mode a foodstuff tank is arranged at or in the feed unit and connected in a fluid conducting fashion to the feed line, and in the cleaning mode, instead of the foodstuff tank, the cleaning agent mixing container is arranged at or in the feed unit and the feed line is connected thereto in a fluid conducting fashion.

In a preferred embodiment the safety is increased by excluding other potential sources for errors in that it is checked if the cleaning agent mixing container is arranged at or in the feed unit. Accordingly, in one preferred embodiment the feed unit comprises a detector for detecting the cleaning agent mixing container.

This way it is possible to embody the control of the feed unit depending on the detection if the cleaning agent mixing container is arranged at or in the feed unit. In particular, preferably a cleaning processes can be blocked if no cleaning agent mixing container is detected, i.e. a cleaning process is only possible with a cleaning agent mixing container arranged at or in the feed unit.

Preferably the feed unit comprises here a control unit, which is embodied such that it cooperates with the above-mentioned detector for the detection of the cleaning agent mixing container such that any cleaning process is only possible when the cleaning agent mixing container is arranged at or in the feed unit.

It is also within the scope of the invention that the above-mentioned control unit is arranged in the beverage dispensing device and assumes the above-mentioned control functions.

The detection of the cleaning agent mixing container can occur via the detector in a manner known per se. Preferably, the cleaning agent mixing container comprises at least one coding and the detector is embodied to detect said coding. In particular, the coding can be embodied as a RFID-coding, barcode, or magnetic coding. This way it can be ensured in a simple fashion that only when the cleaning agent mixing container is arranged as intended by the manufacturer here the cleaning process can be performed. It is particularly prevented that the operator uses a different, unsuitable mixing container at or in the feed unit for executing the cleaning process.

Another advantage of the feed unit according to the invention is the fact that the cleaning agent is first conveyed from the cleaning agent tank into the cleaning agent mixing container and subsequently it is conveyed therefrom via the feed line for cleaning at least the feed unit. This way in a simple fashion another preparation of the cleaning agent mixing container can occur.

Here, the operator can easily fill a diluent, particularly water, into the cleaning agent mixing container and then, as described above, arrange it at or in the feed unit. This way any dilution of the cleaning agent can be achieved in a simple fashion.

Diluting the cleaning agent from the cleaning agent tank in the cleaning agent mixing container is advantageous in that the cleaning agent in the cleaning agent tank may be embodied as a concentrate and thus require less volume for storage thereof and/or any refilling or exchange of the cleaning agent tank is required less frequently.

Preferably the feed unit comprises a freshwater connection and is embodied such that in the cleaning mode optionally freshwater can be fed to the cleaning agent mixing container. In this preferred embodiment it is therefore not required that the operator him/herself fills any diluent into the cleaning agent mixing container. Rather, preferably directed by a control unit of the feed unit and/or a control unit of the beverage dispensing device, dilution of the cleaning agent fed from the cleaning agent tank into the cleaning agent mixing container can occur automatically by supplying water. Preferably the feed unit is embodied such that optionally heated water, particularly hot water, preferably water having a temperature ranging from 3° C. to 70° C., preferably 30° C. to 70° C. can be supplied to the cleaning agent mixing container. By mixing the cleaning agent of the cleaning agent tank with heated water the cleaning effect can be improved such that less cleaning agent of the cleaning agent tank is required.

The feed unit preferably comprises a receptacle for the foodstuff container. This allows a protected storage of the foodstuff tank. In particular, in another preferred embodiment the receptacle can be embodied as a refrigerator in order to this way increase the shelf-life of the foodstuff, particularly when milk is used.

The cleaning agent mixing container and the receptacle are therefore preferably embodied such that in the cleaning mode the cleaning agent mixing container is arranged in the receptacle instead of the foodstuff container. In another preferred embodiment, as described above, the receptacle comprises particularly a detector which is arranged and cooperates with the cleaning agent mixing container such that only when the cleaning agent mixing container is arranged in the receptacle here any detection occurs of the cleaning agent mixing container by the detector. Preferably the detector is here embodied and arranged such that only in the event of a correct positioning of the cleaning agent mixing container in the receptacle such detection can occur.

The feed unit according to the invention shows the advantage that the operator only needs to arrange the cleaning agent mixing container at or in the feed unit. Therefore, according to the invention the cleaning agent pump for conveying the cleaning agent is arranged at or in the feed unit and particularly separated from the cleaning agent mixing container. Furthermore, the feed unit preferably comprises a separate receptacle for the cleaning agent tank.

A typical cleaning process therefore requires only that the user, instead of the foodstuff tank, arranges the cleaning agent mixing container at or in the feed unit, connects the feed line in a fluid guiding fashion to the cleaning agent mixing container, and perhaps starts the cleaning process. If a detector is provided for detecting the cleaning agent mixing container, as described above, in another preferred embodiment the cleaning process can start automatically after the cleaning agent mixing container has been arranged and it has been detected by the detector.

While the cleaning agent mixing container is removed from the respective receptacle and/or refrigerator in the foodstuff dispensing mode, thus after conclusion of the cleaning process, and is replaced by a foodstuff tank, for example a classical milk carton, the cleaning agent tank remains in its separate receptacle in the feed unit and only needs to be exchanged or refilled after complete consumption of the cleaning agent.

Due to the fact that a cleaning agent concentrate may be used as the cleaning agent, as described above, any filling and/or exchanging of the cleaning agent tank is required only rarely, so that during the overwhelming majority of the cleaning processes the operator only needs to manipulate the cleaning agent mixing container.

This leads to another advantage, that the cleaning agent mixing container is embodied preferably without any technical components, such as pumps, and particularly without any separate lines, so that the cleaning agent mixing container can be easily cleaned, for example in a dishwasher. Furthermore, by removing the foodstuff tank and replacing it with a cleaning agent tank it is ensured that no cleaning agent can reach into the foodstuff tank.

If a refrigerated receptacle is provided for the foodstuff tank, as described above, the feed unit is preferably embodied such that the cleaning agent tank is arranged outside the refrigerated section of the feed unit in order to prevent any unnecessary energy consumption for cooling the cleaning agent and to optimize the cleaning effect of the cleaning agent, which typically worsens at lower temperatures.

The feed unit preferably comprises a feed pump in a manner known per se, which at the suction side is connected to the feed line. At the pressure side the feed pump may be connected to other components of the feed unit and/or the beverage dispensing device in a manner known per se, that for example dispensing a foodstuff suctioned via the feed pump through the feed line to the foodstuff tank is possible via a discharge opening of the beverage dispensing device, perhaps after processing the foodstuff, for example frothing.

The fluid conducting connection between the cleaning agent mixing container and the feed line can occur in a manner known per se: The scope of the invention includes that the feed line is embodied in a flexible fashion, particularly as a flexible hose and is introduced by the operator via an opening provided at a top of the cleaning agent mixing container into said cleaning agent mixing container. In particular it is preferred to embody the cleaning agent mixing container as a vessel open towards the top. The scope of the invention also includes that the cleaning agent mixing container comprises a connection which, upon arranging the cleaning agent mixing container at or in the feed unit, is automatically connected in a fluid-conducting fashion to a corresponding connection of the feed line, arranged fixed at the feed unit.

In another preferred embodiment of the method according to the invention a waiting time or a starting time is predetermined and the cleaning process occurs only after the expiration of said waiting time and/or at the predetermined starting time. This way the cleaning process can easily occur in an automated fashion, particularly at a point of time at which no disturbance of the operator may develop by the cleaning process. In particular, this way in a simple fashion the cleaning can occur at night, for example.

### BRIEF DESCRIPTION OF THE DRAWINGS

In the following, additional preferred features and preferred embodiments are explained based on exemplary embodiments and the figures. Shown are:

FIG. 1A is a detail of a first exemplary embodiment of a feed unit according to the invention to be arranged next to a beverage dispensing device with an inserted foodstuff tank and FIG. 1B is a detail with an inserted cleaning agent mixing container, and

FIG. 2 a second exemplary embodiment of a feed unit according to the invention integrated in a beverage dispensing device.

### DETAILED DESCRIPTION OF THE PREFERRED EMBODIMENTS

The figures show schematic illustrations, which are not true to scale, in which for a simpler representation components known per se were omitted. Identical reference characters in the figures indicate identical elements or elements generating the same effect.

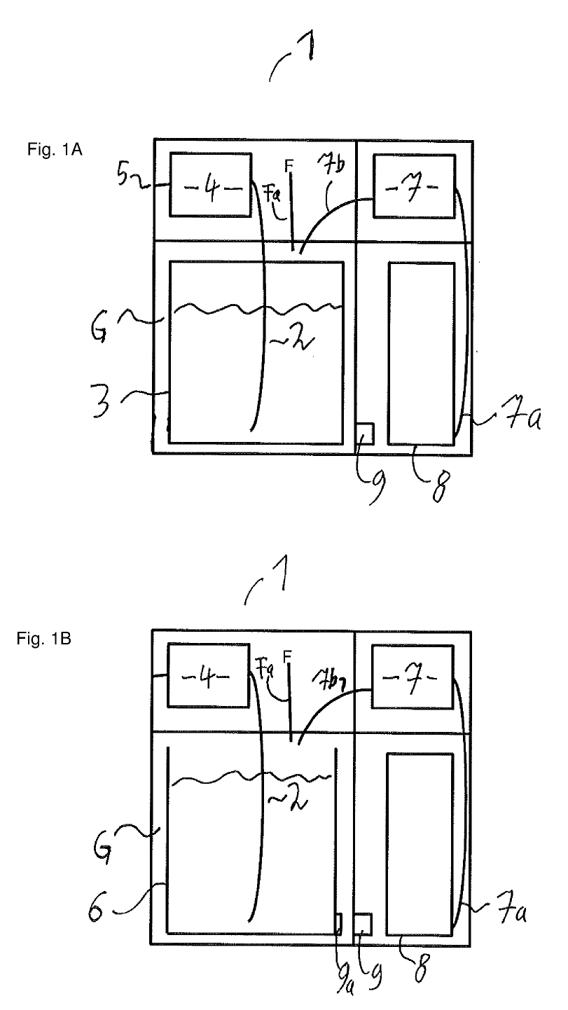

The first exemplary embodiment of a feed unit 1 shown in FIG. 1A comprises a feed line 2 for feeding a liquid foodstuff, in the present case milk, from a foodstuff tank 3.

The foodstuff container 3 is here arranged in a refrigerated section G of the feed unit 1. With the feed pump 4, which is connected at the suction side to the feed line 3, therefore milk can be conducted from the foodstuff container 3 to a feedstuff discharge connection 5. During operation this foodstuff discharge connection 5 is connected in a fluid-conducting fashion to a foodstuff input connection of a beverage dispensing device, not shown, in the present case an automatic coffee maker. In order to produce a coffee-milk mixed drink, here coffee is brewed by the beverage dispensing device and by a control unit of the beverage dispensing device issuing control signals the feed pump 4 is controlled via an interface, not shown, to the feed unit such that milk in the foodstuff container 3 is fed at the desired volume via the foodstuff discharge connection 5 of the beverage dispensing device.

The feed line 2 is here introduced via an opening at a top of the foodstuff tank 3, not shown, into the foodstuff tank.

FIG. 1A therefore illustrates the typical operating condition in which liquid foodstuff can be fed from the foodstuff tank 3 of the beverage dispensing device. Thus a foodstuff dispensing mode is shown.

FIG. 1B shows a cleaning mode of the feed unit 1. Here the foodstuff tank 3 is replaced by a cleaning agent mixing container 3.

The cleaning agent tank 6 is embodied open at the top so that on the one hand the feed line 2 can be inserted into the cleaning agent mixing container 6 as shown in FIG. 1B. Furthermore, the feed unit comprises a cleaning agent pump 7, which is connected in a fluid conducting fashion via a hose line 7a at the suction side to a cleaning agent tank 8. At the pressure side the cleaning agent pump 7 is connected in a fluid-conducting fashion to another hose line 7b, which ends in an area above the cleaning agent mixing container such that when the cleaning agent mixing container is inserted here cleaning agent can be conveyed out of the cleaning agent tank 8 via the cleaning agent pump 7 into the cleaning agent mixing container 6.

The feed unit further comprises a fixed water connection F, which is connected in a fluid conducting fashion to a hose line FA, which also ends above the cleaning agent mixing container 6 such that fresh water can be supplied thereto when the cleaning agent mixing container 6 is inserted.

Not shown are here particularly any control elements for the electric control of the pumps 4 and 7 as well as controllable valve elements for the optional opening and closing of the fluid-conducting connection between the freshwater connection F and the hose line FA.

The feed line 1 further comprises a detector 9, which is arranged in the non-refrigerated section of the feed unit 1. Accordingly the cleaning agent mixing container 6 comprises a coding embodied as a RFID-coding, which is arranged in the lower section at an exterior of the cleaning agent mixing container 6 such that when the cleaning agent mixing container 6 is inserted the coding 9a is located at a short distance (in the present case approximately 3 cm) from the detector 9. This way here, via a control unit not shown, it can be detected if the cleaning agent mixing container 6 is arranged in the feed unit 1.

In order to implement an exemplary embodiment of the method according to the invention here, instead of the foodstuff tank 3, the cleaning agent mixing container 6 is arranged in the feed unit 1. As soon as the coding 9a is detected by the detector 9 automatically via the cleaning agent pump 7 here cleaning agent is conveyed from the cleaning agent tank 8 into the cleaning agent mixing container 6 and water is added via the fixed water connection F.

The cleaning agent in the cleaning agent tank 8 represents a liquid, concentrated cleaning agent so that after the addition of water here a desired concentration of the cleaning agent can be yielded.

After mixing the cleaning agent with water in the cleaning agent mixing container 6, via the feed pump 4 the mixture of the cleaning agent is conveyed via the feed line 2 to the foodstuff dispensing connection 5 such that on the one side the feed line 2 and the feed pump 4 are cleaned, furthermore however also additional lines and other components of the beverage dispensing device, not shown.

FIG. 1A therefore represents a foodstuff dispensing mode in which the feed line 2 is connected in a fluid conducting fashion to the foodstuff tank 3 and FIG. 1B illustrates the cleaning mode in which the feed line 2 is connected in a fluid conducting fashion to the cleaning agent mixing container 6.

In another exemplary embodiment a tankless heater (not shown) is arranged in the line Fa such that the cleaning agent can be mixed with hot water showing a temperature of 50° C. in order to increase the cleaning effect.

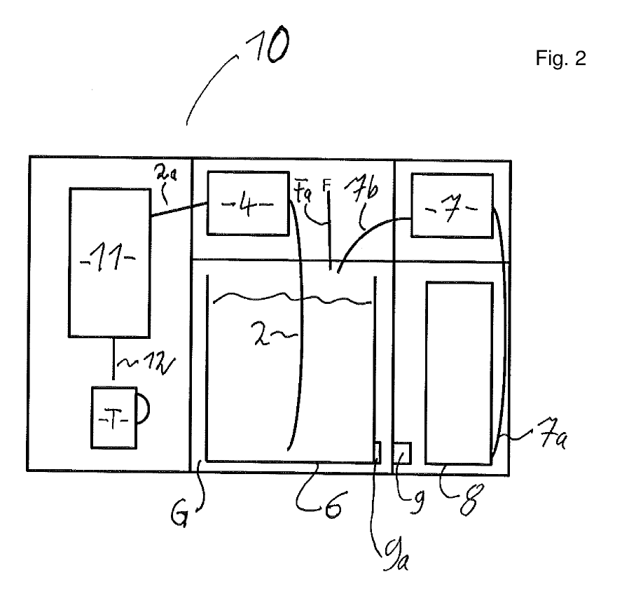

FIG. 2 shows a second exemplary embodiment in which the feed unit is integrated in a beverage dispensing device 10. In order to avoid repetitions here only the differences from the illustration according to FIG. 1B are discussed:

The beverage dispensing device 10 comprises a coffee unit 11 for the fully automated production of coffee, as well as a control unit, not shown.

When in a foodstuff discharge mode, not shown, instead of the cleaning agent mixing container 6 here a foodstuff tank 3 with milk is inserted and connected in a fluid conducting fashion to the feed line 2, in a manner known per se a coffee-milk mixed drink can be produced, for example latte macchiato, and dispensed to a cup T via an outlet 12 of the beverage dispensing device 10.

It is essential that the beverage dispensing device 10 comprises a feed unit which is arranged in a common housing of the beverage dispensing device 10 and is embodied similar to the feed unit shown in FIGS. 1A and 1B.

FIG. 2 shows the cleaning mode of the beverage dispensing device 10: A foodstuff tank 3, not shown, was replaced by the cleaning agent mixing container 6. Cleaning agent concentrate was conveyed via the cleaning agent pump 7 on the cleaning agent tank 7 to the cleaning agent mixing container 6 and diluted with water via the fixed water connection F through the line Fa. Subsequently via the feed pump 4 the diluted cleaning agent is suctioned through the feed line 2 and conveyed through another line 2a of the coffee unit 11 such that the coffee unit 11 is cleaned.

1. A feed unit (1) for feeding a liquid foodstuff to a beverage dispensing device, comprising a feed line (2) for feeding a liquid foodstuff from a foodstuff tank (3) to the feed unit (1), a cleaning agent tank (3) for a cleaning agent, a cleaning agent pump (7) arranged at or in the feed unit for conveying the cleaning agent out of the cleaning agent tank (8), a cleaning agent mixing container (6) separated from the cleaning agent tank (3) and the cleaning agent pump (7), which in a cleaning mode is arrangeable at or in the feed unit (1) and is removable from the feed unit (1) in a foodstuff dispensing mode, wherein in the cleaning mode the cleaning agent can be conveyed is conveyable via the cleaning agent pump (7) out of the cleaning agent tank (8) to the cleaning agent mixing container (6) and at least one of the cleaning agent or a cleaning agent mixture is removable via the feed line (2) from the cleaning agent mixing container (6).

2. The feed unit (1) according to claim 1, further comprising a detector (9) for detecting the cleaning agent mixing device (6), wherein the cleaning agent mixing device (6) comprises at least one coding and the detector (9) is embodied for detecting said coding.

3. The feed unit according to claim 2, further comprising a control unit, which is embodied to initiate the process of a cleaning program only upon detecting the cleaning agent mixing container (6).

4. The feed unit (1) according to claim 1, further comprising a receptacle for the foodstuff tank (3) and the cleaning agent mixing container (6), the receptacle is embodied such that in the cleaning mode the cleaning agent mixing container (6) is arrangeable in the receptacle instead of the foodstuff tank (3).

5. The feed unit (1) according to claim 1, further comprising a freshwater connection and is embodied such that in the cleaning mode provides for freshwater can optionally to be fed to the cleaning agent mixing container (6).

6. The feed unit (1) according to claim 1, further comprising a separate receptacle for the cleaning agent tank (8).

7. The feed unit (1) according to claim 1, further comprising a feed pump (4) which at the suction side is connected to the feed line.

8. The feed unit according to claim 1, wherein that the feed unit (1) is as a separate unit adapted to be arranged next to a beverage dispensing device (10) and comprises at least one foodstuff dispensing connection (5) for connecting in a fluid conducting fashion to a foodstuff feed connection of the beverage dispensing device (10) and the feed unit (1) is embodied such that the fluidic foodstuff is supplied via the foodstuff dispensing connection (5) of the beverage dispensing device (10).

9. A beverage dispensing device (10), comprising a feed unit (1) according to claim 1.

10. A method for cleaning at least a feed unit (1) for feeding a liquid foodstuff to a beverage dispensing device (10) comprising the following processing steps:
A arranging a cleaning agent mixing container (6) at or in the feed unit (1) and connecting in a fluid conducting fashion a feed line (2) of the feed unit (1) to the cleaning agent mixing container (6);
B feeding at least one cleaning agent from a cleaning agent tank (8) in the cleaning agent mixing container (6);
C removing cleaning agent or a cleaning agent mixture out of the cleaning agent mixing container (6) via the feed line (2) in order to clean at least the feed unit (1);
wherein in a foodstuff dispensing mode the feed line (2) is connected in a fluid conducting fashion to a foodstuff tank (3) and in a cleaning mode the feed line (2) is connected in a fluid conducting fashion to the cleaning agent mixing container (6) instead of the foodstuff tank (3).

11. The method according to claim 10, further comprising carrying out a checking process prior to the processing step C to detect if the cleaning agent mixing container (6) is connected at or in the feed unit (1).

12. The method according to claim 10, further comprising in that diluting the cleaning agent in the cleaning agent mixing container (6).

13. The method according to claim 10, further comprising predetermining a waiting period or starting time and performing the cleaning process only after the expiration of the waiting period or at the starting time.

14. The method according to claim 10, wherein in the foodstuff dispensing mode the foodstuff tank (3) is arranged in a receptacle of the feed unit (1) and for cleaning the cleaning agent mixing container (6) is arranged in the receptacle instead the foodstuff tank (3).

15. The beverage dispensing device of claim 9, wherein the beverage dispensing device is a coffee maker.

16. The feed unit of claim 2, wherein the coding is an RFID coding, a barcode, or a magnetic coding.

17. The method of claim 11, wherein a coding (9a) of the cleaning agent mixing container (6) is checked and only in case of a correct coding (9a), the processing step C is performed.
